(19) United States
(12) Patent Application Publication
(10) Pub. No.: US 2018/0012244 A1
(43) Pub. Date: Jan. 11, 2018

(54) SYSTEM AND METHOD TO DETERMINE PRESCRIPTION DRUG BENEFIT ELIGIBILITY FROM ELECTRONIC PRESCRIPTION DATA STREAMS

(71) Applicant: SENTRY DATA SYSTEMS, INC., Deerfield Beach, FL (US)

(72) Inventor: TRAVIS LEONARDI, DEERFIELD BEACH, FL (US)

(21) Appl. No.: 15/601,666

(22) Filed: May 22, 2017

Related U.S. Application Data
(60) Provisional application No. 62/339,571, filed on May 20, 2016.

(51) Int. Cl. G06Q 30/02; G06Q 30/06; G06Q 10/08; G06Q 50/24; G06F 19/00

(52) U.S. Cl. CPC G06Q 30/0207; G06Q 50/24; G06F 19/3462; G06Q 10/087; G06Q 30/0601

(57) ABSTRACT

Example embodiments of a system, apparatus, and method are disclosed for determining eligibility of a prescription for a discount benefit program from one or more electronic prescription data streams. The embodiments may specify at least one eligibility check on the one or more electronic prescription data streams for confirming whether the covered entity is eligible to replenish dispensed medication under a drug discount program, and process prescription data associated with medication that has been dispensed. The example embodiments may include applying the at least one eligibility check to the electronic prescription data to generate an eligibility determination indicating whether the covered entity is eligible to replenish the dispensed medication under the drug discount program, and, in response to the eligibility determination indicating that the covered entity is eligible, automatically ordering replenishment of the medication and causing physical delivery of the ordered medication.

### CROSS REFERENCE TO RELATED APPLICATIONS

This application claims priority from U.S. Provisional Ser. No. 62/339,571 filed on May 20, 2016 entitled “System and Method to Determine Prescription Drug Benefit Eligibility from Electronic Prescription Data Streams,” the entire disclosure of which is herein incorporated by reference in their entirety.

### FIELD OF THE INVENTION

The invention relates to systems and methods for automatically determining eligibility to dispense medication under a drug discount program using electronic prescription data. Among other fields and applications, the invention has utility in facilitating compliance with a drug discount program by verifying eligibility against electronic prescription data.

### BACKGROUND

The U.S. federal government provides a 340B Drug Pricing Program that enables certain eligible healthcare organizations, referred to as Covered Entities (CEs), to receive discounts on drug prices. The 340B program is designed to ease the financial burden on institutions that disproportionately serve patients who are unable to pay for services they receive. CEs may be nonprofit health care organizations that meet certain Federal designations or receive funding from specific Federal programs that can purchase discounted drugs through the 340B Program. Examples of CEs include Disproportionate Share Hospitals (DSH), Sole Community Hospitals (SCH), Rural Referral Centers (RRC), Critical Access Hospitals (CAH), Children's Hospitals, Free Standing Cancer Centers, Community Health Centers (CHC), and Federally Qualified Health Centers (FQHC).

The 340B program reduces the cost of goods (typically medications) provided as part of care in the eligible Outpatient (OP) areas of a hospital. These price reductions typically result in savings on eligible OP pharmaceutical purchases. In some instances, a CE may contract with a pharmacy (contract pharmacy or CP), which dispenses medication for the CE. Cost savings under the 340B program result from discounts given by drug manufacturers, who offer reduced drug prices in order to participate in other government programs, such as drug reimbursement under Medicaid.

To benefit from the 340B program, CEs are required to follow stringent rules and regulations. For instance, to be a compliant eligible dispensation of medication and available for replenishment of the drug under the 340B program, the following conditions must be met: (1) the medication is dispensed to an outpatient of the CE, (2) the medication is dispensed in an eligible outpatient location, (3) the medication's 11-digit National Drug Code (NDC) at dispensation matches the NDC of the medication purchased from a wholesaler, (4) an eligible physician orders the dispensation, (5) the medication is provided for an eligible service, (6) data on the dispensation is tracked accurately and is available for auditing, and (7) the medication is dispensed to a patient for whom the covered entity maintains responsibility for care.

While there are many benefits to the 340B program, complying with the regulations can be difficult for CEs and CPs. Many federally mandated programs that control pharmaceutical product discounts and assistance programs require health providers to assess patient, provider and facility eligibility. These eligibility mandates have required the integration of information from Hospital Information Systems (HIS), Electronic Medical Records (EMR) systems, insurance adjudication systems, and other similar health data systems. While some entities provide limited electronic prescription eligibility assessments for the 340B program (e.g., Pharmaceutical Specialties Group, and CaptureRx, to name only a few), current eligibility are do not provide a robust, automated assessment of eligibility.

### SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

Example embodiments of a system, apparatus, and method are disclosed for determining eligibility for a prescription drug discount benefit program using particular data fields from a data stream originating with a CE.

In one embodiment, computer-implemented method may determine the eligibility of a prescription indicated within a set of electronic prescription drug data for a prescription drug discount program. The method may receive a first stream of electronic prescription data that may be used to determine if the resulting dispensation of medication is eligible for a prescription drug discount program. In response to determining that the prescription data set may provide eligibility for the prescription drug discount program, the method may create a record of eligibility data. The method may then receive a second stream of electronic prescription data and determine if the record of eligibility data matches the second stream of electronic prescription data. In response to determining that the eligibility record matches the second stream of electronic prescription data, the method may confirm and record the eligibility of given medication dispensation. In some embodiments, at least one of the first stream of electronic prescription data or the second stream of electronic prescription data may include data in NCPDP SCRIPT format and may process at least one of the first stream of electronic prescription data or the second stream of electronic prescription data into a common data specification. The common data specification may include one or more of patient information, a date for the prescription data set, a prescriber, a drug, a hospital location, and a provider.

### BRIEF DESCRIPTION OF THE DRAWINGS

The invention may be better understood by reference to the detailed description when considered in connection with the accompanying drawings. The components in the figures are not necessarily to scale, emphasis instead being placed upon illustrating the principles of the invention. In the figures, like reference numerals designate corresponding parts throughout the different views.

FIG. 1 shows a block diagram illustrating example aspects of a system for eligibility verification as part of drug dispensation in accordance with example embodiments.

FIG. 2 illustrates one example of a longitudinal patient record in accordance with example embodiments.

FIG. 3 illustrates one example of a functional diagram of some elements involved in eligibility verification using electronic prescription data.

FIG. 4 illustrates one example of a covered entity eligibility settings record in accordance with example embodiments.

FIG. 5 illustrates one example of a flow chart of a method for performing eligibility determination and verification in accordance with example embodiments.

FIG. 6 illustrates one example of a special-purpose computing device for eligibility determination and verification as part of drug dispensation in accordance with example embodiments.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meanings have otherwise been set forth herein.

### DETAILED DESCRIPTION

The present invention now will be described more fully with reference to the accompanying drawings, which form a part hereof, and which show, by way of illustration, specific exemplary embodiments by which the invention may be practiced. These illustrations and exemplary embodiments are presented with the understanding that the present disclosure is an exemplification of the principles of one or more inventions and is not intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods, systems, computer readable media, apparatuses, or devices. Accordingly, the present invention may take the form of an entirely hardware embodiment, an entirely software embodiment, or an embodiment combining software and hardware aspects. The following detailed description is, therefore, not to be taken in a limiting sense.

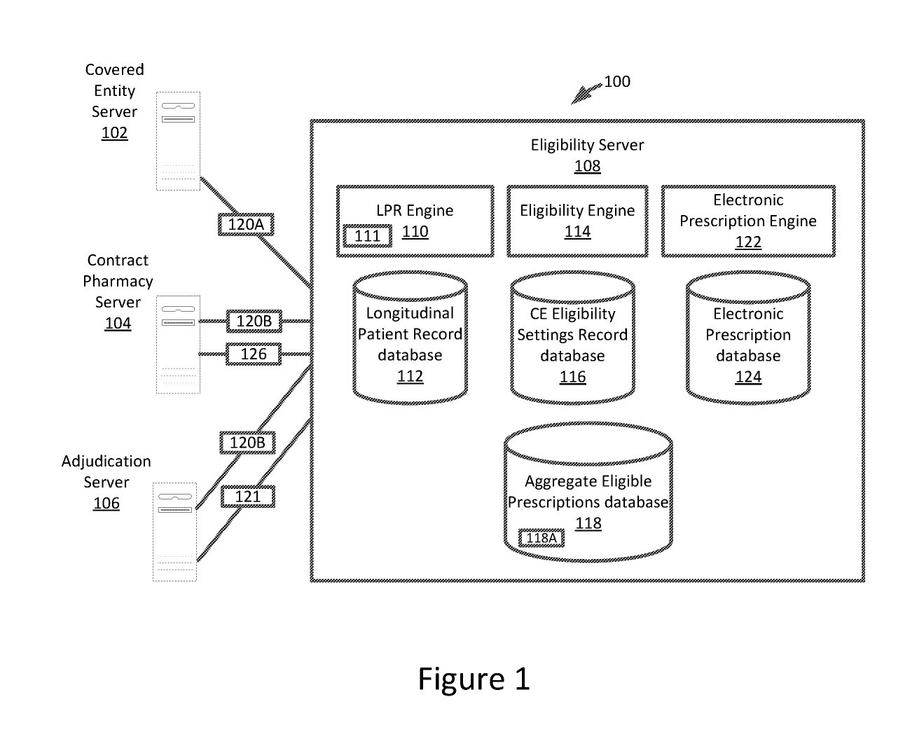

The example embodiments relate to utilizing data collected from a covered entity for verifying eligibility to replenish medication under a drug discount program. FIG. 1 illustrates a block diagram of a system 100 in accordance with example embodiments. System 100 may include a covered entity (CE) server 102, a contract pharmacy (CP) server 104, and an adjudication server 106 communicatively coupled to an eligibility server 108 by a direct connection or via one or more computer networks (e.g., local area network, wide area network, wireless network, wired network, and the like, and/or some combination thereof). In some examples, the CE may not have a relationship with a CP, and instead the CE may have its own pharmacy for dispensing drugs to its patients. In such a scenario, the CP server 104 may be omitted and the CE server 102 may perform the CP's functions described herein.

The eligibility server 108 may maintain longitudinal patient records for a patient population and may use the longitudinal patient records to verify eligibility to replenish medication under a drug discount program. The following describes the drug discount program as the U.S. Federal Government's 340B program. The concepts described herein, however, may be applied to any other drug discount program.

The eligibility server 108 may include a number of engines for processing data, including a longitudinal patient record (LPR) engine 110 and an eligibility engine 114. Each engine described herein may be a discrete piece of hardware hard coded to perform the functions described herein. In other examples, the functions of an engine may be implemented in software as computer readable instructions stored in memory whereby execution of the computer readable instructions by at least one processor cause the at least one processor, or at least one computer, server, or other device, to perform the functions described herein. In yet other examples, any of the engines and functions described herein may be implemented as discrete pieces of hardware and others may be implemented in software. In other examples, an engine may include at least one processor and at least one memory storing computer executable instructions that, when executed by the at least one processor, cause the at least one processor, computer, server, or other device, to perform the functions described herein. In further examples, some functions performed by an engine may be implemented as one or more discrete pieces of hardware and other functions may be implemented in software.

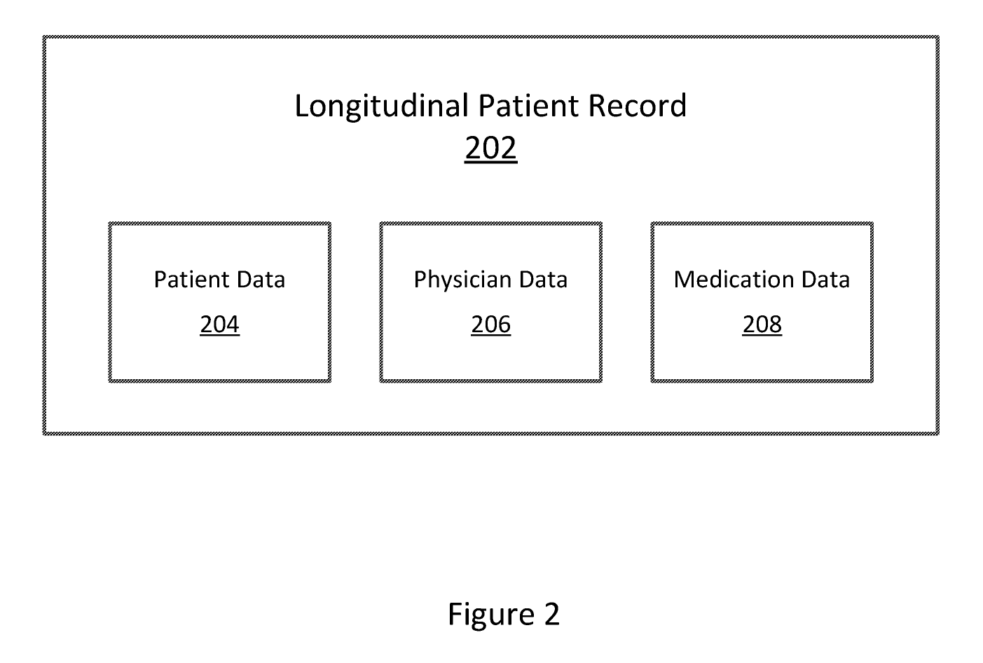

The LPR engine 110 may maintain an LPR database 112 storing LPRs for a patient population. In an example, an LPR may be an electronic database record of a patient's medical history including diagnoses, treatments, service locations, service dates, service providers and related financial, clinical and demographic information. As depicted in FIG. 2, each LPR 202 may include one or more of patient data 204, physician data 206, and medication data 208.

The patient data 204 may identify a patient's name and home address, a diagnosis code indicating one or more diseases with which a patient has been diagnosed, what services the patient has received, dates and locations of each service, and the like. The physician data 206 may include information identifying each treating physician a patient has seen, what diagnosis each physician has made, with what hospital or treatment facility the physician is affiliated, any referral relationships between the physician and other physicians, and the like. The medication data 208 may identify what medications have been prescribed to a patient, the prescribing physician, dates of prescription, how many times a prescription has been refilled, a drug identifier of the medication (e.g., an NDC code), and the like.

Periodically or at various times, the LPR engine 110 may receive patient record data 111 from one or more of the CE server 102, the CP server 104, and the adjudication server 106 to update a patient's LPR 202 and/or to determine whether an issued medication is eligible for replenishment under the drug discount program. In some embodiments, the LPR engine 110 may also receive electronic prescription data 120A from an electronic prescription data engine 122. In one example, the electronic prescription data 120A may be received from a covered entity server 102 or other device and may include National Council for Prescription Drug Programs data (i.e., NCPDP SCRIPT data) or any other standard for electronic prescription data. The electronic prescription data 120A may include data indicating that an electronic prescription has been generated at a covered entity server 102 and data corresponding to the prescription particulars. The patient record data 111 may be treatment data for indicating what treatments a patient has received, prescription data for indicating what prescribed medications have been dispensed to the patient, and/or Price and Availability (P&A) data indicating current prices and the availability of prescribed medication for restocking the CP's inventory from the CE's distributors with pricing availability according to each distributor's accounts with the CE. In some examples, drugs that are not available would be considered ineligible for replenishment.

In an example, the LPR engine 110 may receive patient record data 111, electronic prescription data 120A and other data from the CE server 102 or other entities in substantially real-time, at predetermined times (e.g., nightly), and the like. Patient record data 111 may include a patient identifier (e.g., code, name, or other information for identifying a patient), date of treatment, type of treatment, identifier of treating physician, location within a hospital that rendered the treatment, and the like. The electronic prescription data 120A received from the CE server 102 may include a variety of data related to a prescription including a patient identifier, date written, a prescribing physician identifier, drug type, hospital location, and other data relevant to the prescription as written by the covered entity. The eligibility server 108 may ingest this data 120A into a common data specification including one or more particular pieces of data that may indicate eligibility of that prescription to be refilled under a prescription drug discount program. The LPR engine 110 may update the patient's LPR 202 with the patient record data 111 and the electronic prescription data 120A. For example, the LPR engine 110 may use the patient identifier to search the LPR database 112 to identify the corresponding LPR 202 for updating.

In another example, the LPR engine 110 may receive payment adjudication data 121 from the adjudication server 106. Adjudication data 121 may indicate payment for a medication by a drug identifier (e.g., by NDC code) to be dispensed at the pharmacy. The adjudication server 106 may be part of an insurance company or other payer and configured to create the adjudication data 121 during the process of determining whether a claim for a prescription drug is covered under an insurance policy.

In a further example, an electronic prescription engine 122 of server 108 may receive first electronic prescription data 120A from a CE server 102 as well as second electronic prescription data 1208 from the CP server 104. and/or the adjudication server 106. The adjudication server 106 may then send the data 1208 to a pharmacy where the prescription may be filled for a patient. The engine 122 may compare the data streams 120A, 1208 to determine whether dispensed medications are eligible to be replenished under the drug discount program. For example, the CE server 102 may send electronic prescription data 120A to both the eligibility server 108 and the adjudication server 106 (via the CP server 104). The adjudication server 106 may then send the electronic prescription data 120A to a pharmacy to be filled for a patient. After the prescription is filled, a CP server 104 and/or the adjudication server 106 may return the filled prescription data 1208 to the eligibility server 108 in the form of a switch data feed.

In some embodiments, a CE may be eligible to order medication at a discounted price, but may have in the past forgone doing so because the CE may not have appropriate controls for determining compliance with the drug discount program. The CE thus loses money because it allows the CP to restock its inventory with medication that could have been replenished at a discounted price via the CE's drug discount program. To overcome this issue, the eligibility engine 114 performs eligibility checks on first prescription data 120A from the CE server 102 and creates an eligibility record 118A to be stored in the aggregate eligible prescriptions database 118. Once the prescription is first filled, the electronic prescription engine 122 may receive second electronic prescription data from the adjudication server 106 or the CP server 104. The engine 122 may compare an eligibility record 118A to the second electronic prescription data 1208 to determine which, if any, of the dispensed medications is eligible to be replenished under the drug discount program. The eligibility engine 114 thus creates a record that can be produced should an audit of the CP occur.

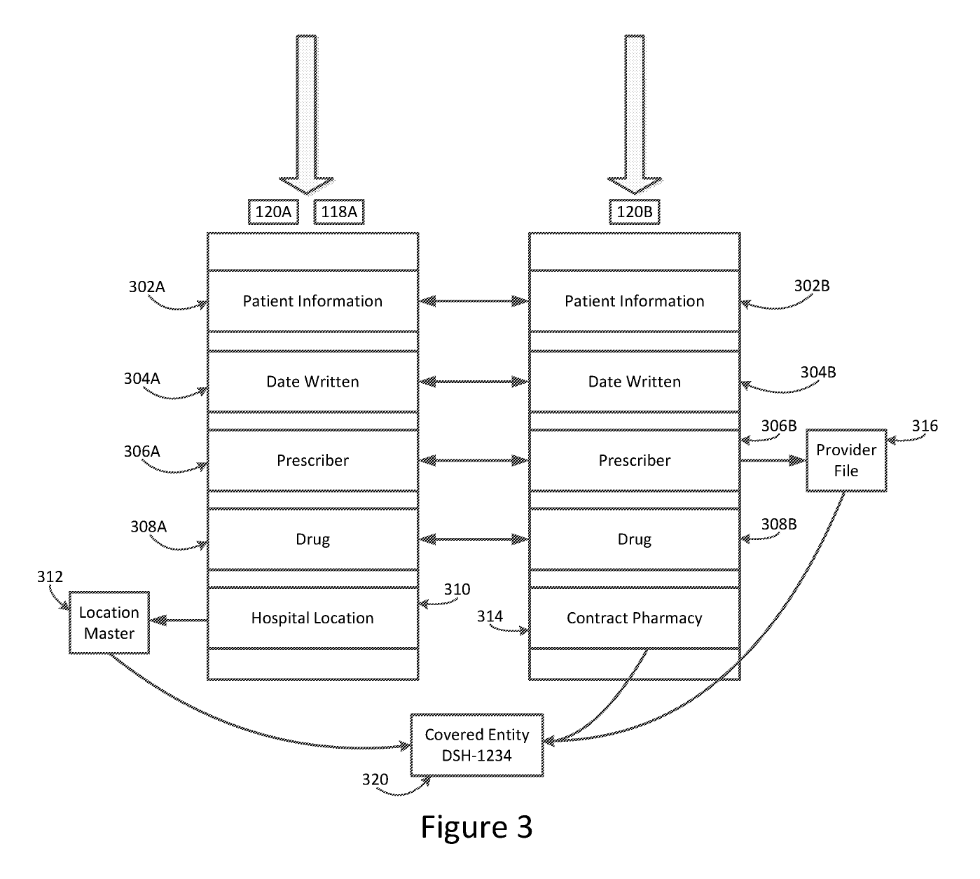

In an example, when a prescription is written by a physician and entered into an electronic medical records system at the covered entity (e.g., the Epic® EMR system or similar), the CE server 102 may communicate electronic prescription data 120A to the eligibility server 108. The electronic prescription engine 122 may then process the data 120A into a common data specification and store the specified data in an electronic prescription database 124. In some embodiments, the common data specification may include a combination of the data 302A, 304A, 306A, 308A, 310, 312, 314, and 316 as shown and described in relation to FIG. 3. The eligibility engine 114 may then determine if the data 120A is valid for a prescription drug discount benefits program. If valid, the eligibility engine may store an eligibility record 118A in the database 118. When the prescription corresponding to the electronic prescription data 102A is filled, the adjudication server 106 and/or the CP server 104 may communicate prescription data 1208 to the eligibility server 108. The electronic prescription engine 122 may then process the data 1208 into the common data specification and store the specified data in an electronic prescription database 124. Similar to the prescription data 120A received from the CE server 102, the prescription data 1208 received from the adjudication server 106 and/or CP server 104 may include a patient identifier to identify the patient who received the medication, the date the prescription was written, a prescribing physician identifier, the date the prescription was filled, and the like. The electronic prescription engine 122 then processes the prescription data 120A and/or 1208 to identify its patient identifier, date written, prescriber, drug type, contract pharmacy, and other information, and may use this data to identify the patient's corresponding LPR 202 and update the LPR 202.

In some embodiments, the electronic prescription data 120A, 1208 may be formatted by the sender (i.e., the CE server 102, the CP server 104, the adjudication server 106, etc.) for a particular data specification to determine eligibility for a benefits program. In other embodiments, the eligibility server 108 may receive the electronic prescription data 120A, 1208 as an unspecified data stream. Where the received electronic prescription data is unspecified, the eligibility server electronic prescription engine 122 may organize and format the data 120A, 1208 to conform to its data specification or may select a combination of data elements from the data feeds to determine one or more eligibility factors. For example, the electronic prescription engine 122 may determine a patient's missing first name by cross-referencing a patient's last name and telephone number with an existing patient record.

The electronic prescription engine 122 may compare the prescription data 1208 to eligibility records 118A to determine whether a CE is eligible to replenish a prescribed drug under the drug discount program. With reference to FIG. 3, in an example, the eligibility server 108, in general, and the eligibility engine 114 and electronic prescription engine 122, in particular, may include one or more instructions that, when executed by a processor, cause the system 100 to perform one or more eligibility checks between the stored eligibility records 118A and/or the first electronic prescription data 120A and the electronic prescription data 1208 to determine whether a CE that prescribed a drug dispensed by a CP is eligible to replenish the prescribed drug under the drug discount program. In some embodiments, the eligibility server 108 may compare the electronic prescription data 120A raw feed or stored, specified data 120A from the CE server 102 to the electronic prescription data 1208 raw feed or stored, specified data 1208 from the CP server 104. In other embodiments, the server 108 may compare eligibility records 118A and/or the first electronic prescription data 120A with the second electronic prescription data 1208. For example, when the elements of data feeds 120A and 1208 match or the elements of an eligibility record 118A and the data feed 1208 match to meet the eligibility requirements for the prescription drug benefits program, then the drug may be replenished under the program. In some embodiments, the engine 108 may match data from the first stream of electronic prescription data 120A that has been processed into the common data specification to the data feed 1208. For example, the engine 108 may match patient information 302A, 302B, date written 304A, 304B, prescriber 306A, 306B, and drug 308A, 308B from the respective data feeds 118A and/or 120A, 1208 as an initial measure. A combination of the data 302A, 304A, 306A, 308A and 310 may encompass the common data specification. Then, the eligibility engine 108 may compare the hospital location 310 from the eligibility record 118A and/or electronic prescription data 120A feed to a location master list 312 and the prescriber 306B to a provider file 316 to determine a match. If all data matches, then the prescription is eligible for a discount benefit 320 and the eligibility server 108 may send a confirmation of replenishment eligibility 126 to the pharmacy server 104 or other entity on behalf of the CE.

In some embodiments, the CE may select a set of eligibility checks it wishes to apply to the data feed 120A, and the eligibility engine 114 may apply the selected checks to determine whether a prescribed drug is eligible to be replenished under the drug discount program and to create an eligibility record 118A. When the CE selects on which eligibility checks it wishes to rely, the CE may assume the desired level of risk for non-compliance with rules of the drug discount program. For example, the greater the number of eligibility checks performed by the eligibility engine 114, the less likelihood that the eligibility engine 114 will find a drug eligible for the drug discount program when, in fact, it is ineligible. Conversely, the fewer checks performed, the higher the likelihood that that the eligibility engine 114 will erroneously find a drug eligible for the drug discount program when, in fact, it is ineligible.

The eligibility engine 114 may provide an interface (e.g., web-based) permitting a CE to select the desired eligibility checks. The eligibility engine 114 may store a record of each CE's selected eligibility settings in database 116. In an example, an administrator of a CE may use a web-based interface to select the desired eligibility checks and optionally may prompt for a desired risk rate. An error may occur when the eligibility engine 114 determines that a drug is eligible for replenishment under the drug discount program when it is ineligible. The interface may also inform the administrator about any mandatory eligibility checks, and may provide the administrator with information for benchmarking compared to its peers. For example, the interface may inform the administrator the percentage of competing peer CEs that require a particular eligibility check (e.g., 73% of peer CEs require a particular check). The eligibility engine 114 may estimate a risk rate for the selected eligibility checks, and may make a recommendation of one or more additional eligibility checks that would provide a greatest amount of reduction in the risk rate. For example, the drug discount program may require that the CE have no greater than a 3% risk rate, and the eligibility engine 114 may determine that a selected group of eligibility checks may result in an estimated risk rate of no greater than 3.5%. The eligibility engine 114 may determine the estimated risk rate based on empirical data on error rates for each eligibility check or combination of eligibility checks. The eligibility engine 114 may determine, based on processing empirical data, that adding one or more additional eligibility checks would decrease the estimated risk rate by an additional 0.8%, and may recommend via the interface that the administrator add that check.

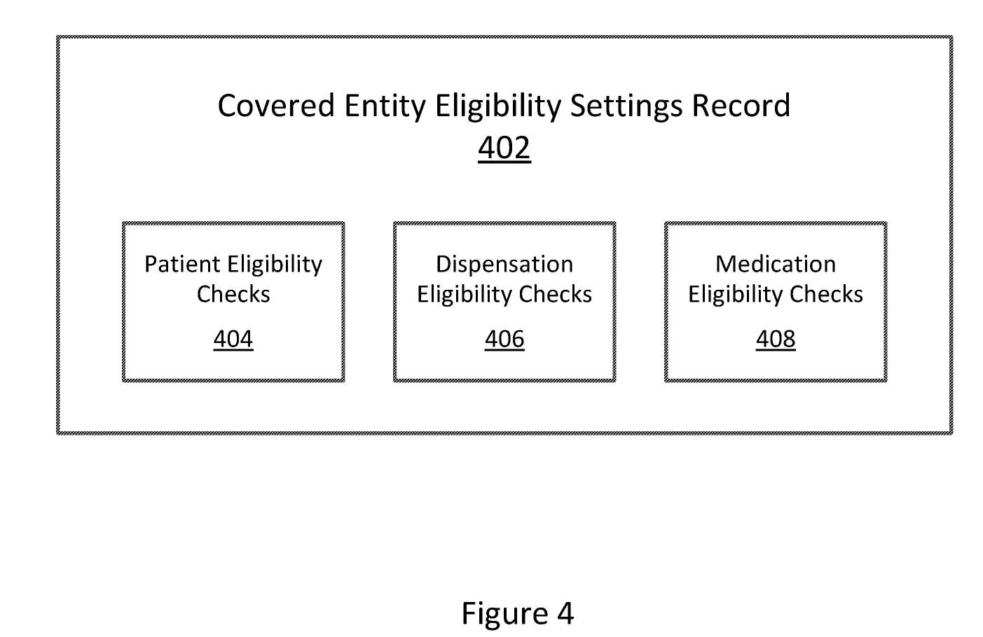

With reference to FIG. 4, the eligibility server 108 may create a record 402 based on the eligibility check settings selected by the CE and store the record 402 in the CE Eligibility Settings Record database 116. A record 402 may identify the selected patient eligibility checks 404, dispensation eligibility checks 406, and medication eligibility checks 408. Patient eligibility checks 404 may include what rules the CE has selected for determining whether a patient is an eligible patient under the drug discount program. Provider eligibility checks 406 may include what rules the CE has selected for determining whether a provider has been associated with the CE and the patient in a manner eligible for replenishment under the drug discount program. Medication eligibility checks 408 include what rules the CE has selected for determining whether a medication is eligible to be replenished under the drug discount program.

The following describes examples of eligibility checks that may be performed alone or in combination with other eligibility checks.

### Patient Eligibility Checks

The example embodiments may perform one or more checks on the data 120A, 1208, and/or the eligibility record 118A to uniquely match a customer of the CP to a patient of the CE. In an example, the eligibility engine 114 may perform an eligibility check by matching a CP patient to a CE's patient using geography, demographics, treatment history, and/or patient identifiers with reasonable confidence based on configurable algorithms. For example, the eligibility engine 114 may be unable to uniquely match an identifier of a CP patient in the prescription data to a single LPR 202, and hence to a single CE patient. The eligibility engine 114 may use information about geography, demographics, treatment history, and/or patient identifiers in an attempt to uniquely associate the CP patient with a single LPR 202. In a more detailed example, received prescription data may identify a patient only by last name (e.g., Smith), but omit the patient's first name. The LPR engine 110 may use the patient identifier to search the LPR database 112 and retrieve one or more longitudinal patient records matching the patient identifier (e.g., all LPRs where the patient's last name is Smith). If multiple LPRs 202 exist for different patients sharing the same last name, the eligibility engine 114 may use demographic data, treatment history, and/or geographic data in an attempt to identify a single patient and that patient's corresponding LPR 202. For example, the eligibility engine 114 may determine where each candidate patient lives, a distance to the CP, the age of the patient, approved treatments for the prescribed drug, and whether each candidate patient has previously been prescribed the dispensed medication. The eligibility engine 114 may then rank the LPR records 202 based on how well each matches information of the CP patient, and select the LPR record 202 having the highest ranking as being the matching patient. The eligibility engine 114 may also require at least a minimum degree of matching. If a requisite degree of match is not identified between the data on the CP patient and any of the LPR records 202, the eligibility engine 114 may determine that this eligibility check is not satisfied.

### Medication Eligibility Checks

The example embodiments may perform one or more checks attempting to confirm that a dispensed medication is eligible for refill under the drug discount program. In an example, the eligibility engine 114 may perform an eligibility check by confirming that a drug was dispensed during an eligible timeframe for a CE and under a contract between the CP and the CE. For example, the CE may contract with one or more CPs that dispense prescriptions written by physicians of the CE. The contract may specify that the prescriptions must be filled within a predetermined amount of time (e.g., within three days, within one week, within one month, etc.) to comply with the drug discount program. When performing the eligibility check, the eligibility engine 114 may process the prescription data to determine the date the prescription was issued and the date the prescription was filled. If the eligibility engine 114 determines that the difference between the issued date and the filled date is less than the predetermined amount of time, the eligibility engine 114 may confirm that the drug was dispensed during the eligible time frame. The eligibility engine 114 may perform similar eligibility checks by confirming that dates of a hospital service, prescription date of service, and prescription date written match according to type of service within allowable CE configured timeframes. If the eligibility timeframe is not satisfied, the eligibility engine 114 may determine that this eligibility check is not satisfied.

In another example, the eligibility engine 114 may perform an eligibility check by confirming that a dispensed drug may be replenished under the drug discount program (e.g., has an NDC eligible to be replenished under 340B program). For example, the eligibility engine 114 may compare an NDC code received in the prescription data to a list of NDC codes for drugs eligible for replenishment under the drug discount program. If on the list, the eligibility engine 114 may confirm that the drug passes this eligibility check. Otherwise, the check is not satisfied.

In a further example, the eligibility engine 114 may perform an eligibility check by determining whether a drug is an allowable drug according to CE configured lists. For example, a CE may provide a list of drugs that it is enrolled to replenish under the drug discount program. This list may differ from the list of NDC codes for drugs eligible for the drug discount program. This list may differ due to financial or operational challenges in replenishing the drugs. For instance, C2 level controlled substances may often be omitted due to the complexity to replenish and the increased risk in handling.

In another example, the eligibility engine 114 may perform an eligibility check by determining whether a prescription has a pricing structure allowable by entity-configured parameters. For example, a CE and CP may have contracted to only consider prescriptions as eligible if they are profitable to the CE. If the cost of the drug to replenish under the drug discount program along with the cost of the fees of the contracts are greater than the revenue for the prescription, it will be considered ineligible.

### Provider Eligibility Checks

The example embodiments may perform one or more checks attempting to verify a relationship between a prescribing physician and the CE. In an example, the eligibility engine 114 may perform an eligibility check by determining whether a prescribing physician is approved by the CE, and associated with both the patient's service and the prescription within entity configured parameters. The CE can configure its eligibility settings stored in database 116 to specify whether referrals are allowed and how referrals must be documented. For example, the eligibility engine 114 may receive prescription data identifying the prescribing physician and what service the physician performed on the patient. The eligibility engine 114 may compare the prescribing physician to a list of physicians approved by the CE. If on the list, the eligibility engine 114 may compare the service performed to a list of services the approved physician is eligible to perform. If an approved physician performed an approved service, the eligibility engine 114 may determine that the eligibility check is satisfied. If the physician or the service is not approved, the eligibility engine 114 may optionally apply rules for referrals from other eligible physicians, and if no allowable connection between the patient, the CE and the prescribing physician is found, the eligibility engine 114 may determine that the eligibility check is not satisfied.

The eligibility engine 114 may perform an eligibility check by determining a referral relationship through entity-configured settings and methods. For example, a physician of the CE may be the primary caregiver for a patient, but may refer a patient to another physician. In an example, a CE may establish a referral contract with a physician or other health care provider. When prescription data is received, the eligibility engine 114 may determine whether a referral relationship exists between the physician who wrote the prescription and the CE. If eligibility engine 114 identifies such a relationship and the relationship complies with the referral contract, the eligibility engine 114 may determine that this eligibility check is satisfied.

The eligibility engine 114 may perform an eligibility check by checking some or all payors for the prescription against an entity-configured exclusion list. In an example, the CE may identify a list of payors who are excluded from participating in the drug discount program. Excluded payors may include Medicaid Fee for Service (FFS) programs, Medicaid Managed Care organizations that submit for rebates or AIDS Drug Assistance Programs (ADAP). Each of these programs may collide with the CE's Drug Discount Program and cause the manufacturer to face a duplicate discount. When the prescription data is received, the eligibility engine 114 may determine whether an identified payor is on the exclusion list. If a payor is not on the exclusion list, the eligibility engine 114 may determine that the eligibility check this satisfied. Otherwise, this check is not satisfied.

The eligibility engine 114 may perform an eligibility check by determining whether the location of a hospital service is eligible by entity-configured definition. In an example, the CE may identify a list of eligible hospital locations where a patient is authorized to receive service. For instance, only certain outpatient locations listed as part of the CE may be eligible according to the drug discount program. When the prescription data is received, the eligibility engine 114 may indicate the location of the hospital service. If the patient received a service at a location on the list of eligible locations, the eligibility engine 114 may determine that the eligibility check this satisfied. Otherwise, this check is not satisfied.

The eligibility engine 114 may perform an eligibility check by determining whether a type of service complies with entity-configured settings specified by the CE's record stored in database 116. In an example, the CE may identify a list of services that are eligible to replenish drug inventory under the drug discount program. When the prescription data is received, the eligibility engine 114 may determine what service was provided. If the service is on the list of eligible services, the eligibility engine 114 may determine that the eligibility check this satisfied. Otherwise, this check is not satisfied.

The eligibility engine 114 may perform an eligibility check by determining whether a drug was dispensed to treat a particular ailment. In some instances, eligibility under the drug discount program may depend on what the drug is prescribed to treat. For example, a drug may be eligible when used to treat one type of disease, but not when used to treat any other type of disease.

In some examples, the eligibility engine 114 may determine that a dispensed drug is ineligible for replenishment under a drug discount program by failing to comply with a single eligibility check or a particular combination of eligibility checks. For example, eligibility checks that frequently result in a finding of ineligibility include availability of drug for replenishment from a distributor and payor eligibility. Conversely, the eligibility engine 114 may determine that a dispensed drug is eligible for replenishment under a drug discount program by complying with a single eligibility check or a particular combination of eligibility checks. For example, eligibility checks that frequently result in a finding of eligibility include CE defined “green-lit” plans in which all prescriptions are eligible, or CE defined “sole-employment providers” from whom all written prescriptions are eligible.

In other examples, the eligibility engine 114 may calculate a confidence score associated with some or all of the eligibility checks to reflect how confident the CE may be in relying on an eligibility decision. In one example, the confidence score may be based on how many of the eligibility checks have been performed and passed, and empirical data on how frequently passing eligibility checks alone or in combination incorrectly resulted in a finding of eligibility. For example, empirical data may indicate that passing a particular combination of eligibility checks (e.g., 5 checks) has a predetermined eligibility risk rate (e.g., 0.3%), and thus the confidence score may be 100% minus the risk rate (e.g., 99.7%).

In another example, the eligibility engine 114 may assign a confidence score based on the total number of eligibility checks that have been passed. For example, each eligibility check may have a value of 10 points, and the eligibility engine 114 may determine the confidence score as a total number of points. In another example, the confidence score may be weighted to give a greater number of points to some checks as compared to others.

After making one or more eligibility decisions, the eligibility server 108 may output a report to the CE server 102 listing what medications are eligible for replenishment under the drug discount program, and an amount of benefit as compared to the non-discounted price of the medications and the revenue received from third-parties. Optionally, the report may include the confidence scores for each of the eligibility decisions.

The eligibility server 108 may output the report via a network to a device associated with an administrator of the CE. The administrator device may be a computer, a smartphone, a tablet computer, and the like. In some instances, the administrator device may or may not be in an active state. For example, the administrator device may be in a sleep mode to conserve battery life. Because a report may be time sensitive, the report may cause the administrator device to exit the sleep mode and enter an active state. In some examples, the administrator device may, in response to receiving the report, perform one or more of the following: display the report on a graphical user interface (GUI), emit a sound, and/or establish a network connection for receiving additional data from the eligibility server 108 about the report.

In some examples, the eligibility server 108 may only automatically reorder eligible medications having at least a predetermined confidence score. For instance, when using a point-based confidence score, the eligibility server 108 may only reorder eligible medications having a total score greater than 90 points. In another example, when using empirical data, the eligibility server 108 may only reorder eligible medications having an risk rate below a predetermined percentage (e.g., below 2%).

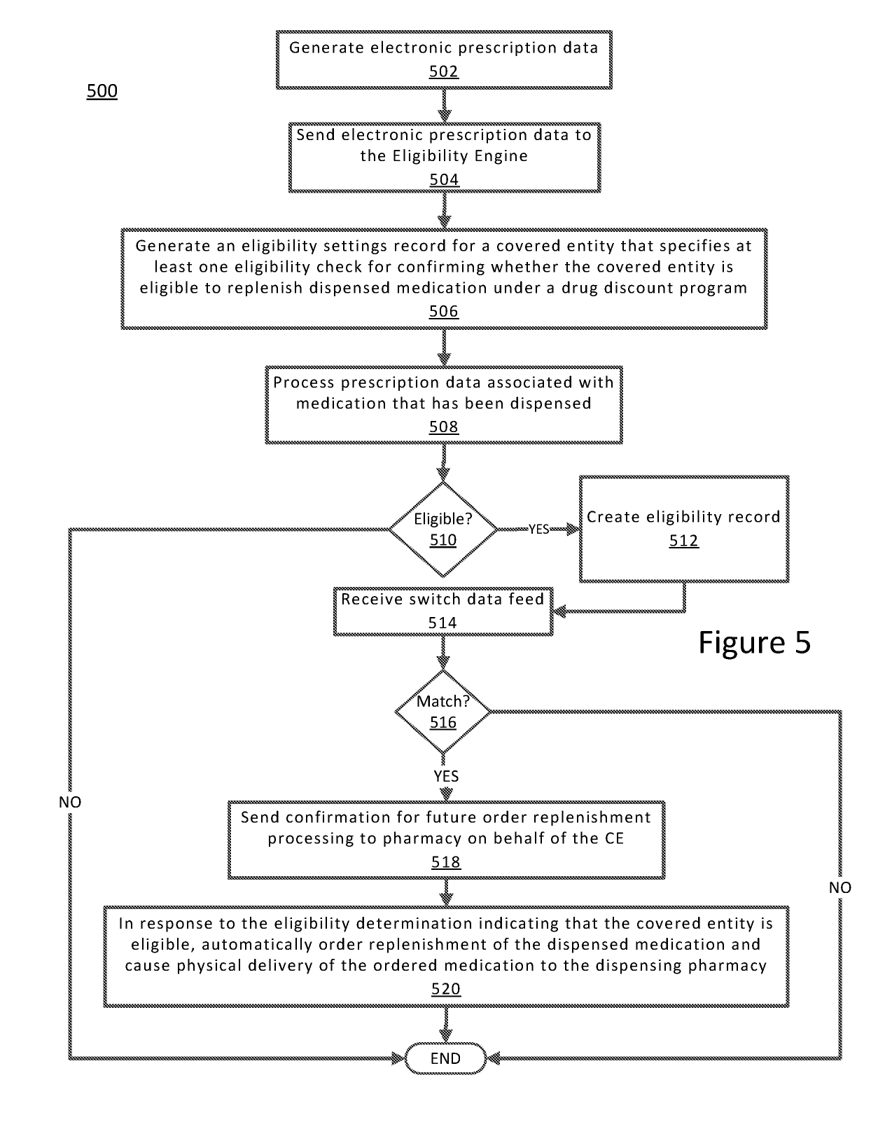

FIG. 5 illustrates a first flow chart of a method 500 in accordance with example embodiments. The method 500 may be implemented by a system or apparatus, such as, for example, eligibility server 108. Each of the blocks shown in the flow diagram may be repeated one or more times, one or more of the blocks may be modified, and one or more of the blocks may be omitted. The method may be stored on a non-transitory computer readable medium as computer executable instructions. The computer executable instructions, when executed by at least one processor, may cause at least one computer or other device to perform the blocks as steps of a method one or more times. The flow diagram may begin at block 502.

With reference to FIG. 5, in block 502, electronic prescription data 120A may be generated by or saved at the covered entity server 102. The data 120A may then be sent by the CE server 102 to the eligibility server 108. The electronic prescription engine 122 may receive electronic prescription data 120A from the covered entity server 102.

In block 506, the method 500 may include generating an eligibility settings record for a covered entity that specifies at least one eligibility check for confirming whether the covered entity is eligible to replenish dispensed medication under a drug discount program.

In block 508, the method 500 may include processing prescription data associated with medication that has been prescribed. In some examples, a contract pharmacy having a relationship with the covered entity may dispense the medication. In other examples, the covered entity may dispense the medication.

In block 510, the method 500 may include applying the at least one eligibility check to the electronic prescription data 120A to determine whether the data 120A indicates whether the covered entity is eligible to replenish the dispensed medication under the drug discount program. In some embodiments, block 510 may include comparing the data 120A to one or more eligibility settings record(s) 402 to perform patient eligibility checks 404, dispensation eligibility checks 406, medication eligibility checks 408, or other comparisons to determine eligibility for a discount program, as described herein.

If, at block 510, the method 500 determines that the data 120A does not indicate a prescription that is eligible for a discount program, then the method 500 may end.

If, at block 510, the method 500 determines that the data 120A indicates a prescription that is eligible for a discount program, then the method 500 creates an eligibility record 118A at block 512. In some embodiments, and with reference to FIG. 3, the eligibility record 118A includes one or more of patient information 302A, a date written 304A, prescriber information 306A, drug information 308A, and hospital location 310.

In block 514, the method 500 may receive second electronic prescription data 1208 or a switch data feed from a CP server 104 and/or the adjudication server 106.

In block 516, the method 500 may compare the eligibility record 118A to the filled prescription data 1208 from the switch data feed to determine whether the two sets of data 118A and 1208 match. If the data sets 118A and 1208 match, then, at block 518, the method 500 may send a confirmation of replenishment eligibility 126 to the pharmacy server 104 on behalf of the CE for future order processing.

In block 520, in response to the eligibility determination indicating that the covered entity is eligible for drug replenishment as part of a drug discount program, the method 500 may automatically order replenishment of the dispensed medication and cause physical delivery of the ordered medication. The ordered medication may be delivered to a mailing address of the covered entity or of the contract pharmacy, or other geographic location.

Advantageously, the example embodiments may facilitate a covered entity's compliance with a drug discount program, provide eligibility checks to verify drug replenishment eligibility under a drug discount program that can be tailored to the covered entity's desired level of risk, and automatically create a record should the covered entity be audited.

Moreover, the example embodiments may provide technical solutions to technical challenges. Existing systems of healthcare providers fail to maintain information and records for determining compliance with a drug discount program. The example embodiments provide technical solutions to these technical challenges by monitoring what medications have been dispensed and reordering medications under a drug discount program that comply with one or more eligibility checks. Further, the example embodiments provide a technical solution to the technical problem of analyzing electronic prescription data to determine eligibility of drug discount programs.

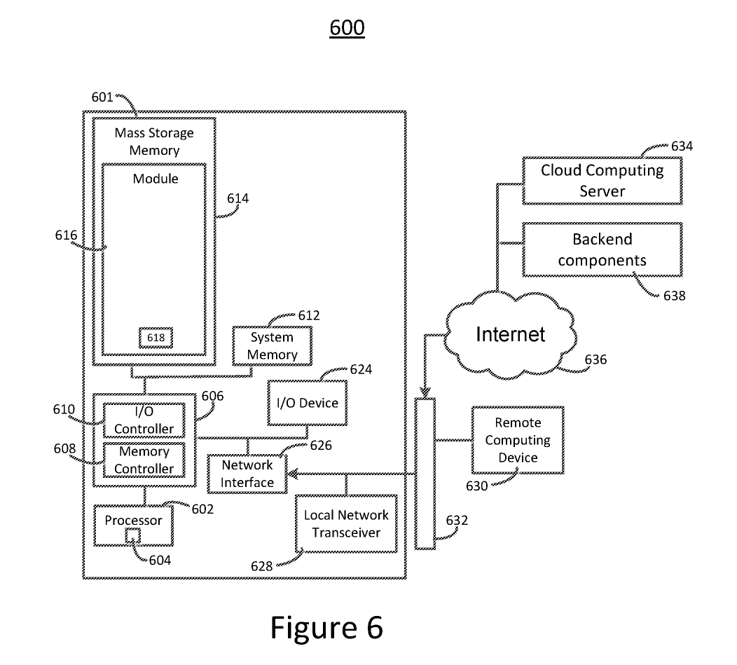

FIG. 6 is a high-level block diagram of an example computing environment 600 for the device and system for masking the identification of a network device as described herein. The computing device 601 may include a server (e.g., the covered entity server 102, the contract pharmacy server 104, the adjudication server 106, etc.), a mobile computing device (e.g., the smart phone), a Wi-Fi-enabled device or other personal computing device capable of wireless or wired communication, a thin client, or other known type of computing device. As will be recognized by one skilled in the art, in light of the disclosure and teachings herein, other types of computing devices can be used that have different architectures. Processor systems similar or identical to the example device, system and method for automatically determining eligibility to dispense medication under a drug discount program using electronic prescription data. Although the example system 600 is described below as including a plurality of peripherals, interfaces, chips, memories, etc., one or more of those elements may be omitted from other example processor systems used to implement and execute the example device or system described herein. Also, other components may be added.

As shown in FIG. 6, the computing device 601 includes a processor 602 that is coupled to an interconnection bus. The processor 602 includes a register set or register space 604, which is depicted in FIG. 6 as being entirely on-chip, but which could alternatively be located entirely or partially off-chip and directly coupled to the processor 602 via dedicated electrical connections and/or via the interconnection bus. The processor 602 may be any suitable processor, processing unit or microprocessor. Although not shown in FIG. 6, the computing device 601 may be a multi-processor device and, thus, may include one or more additional processors that are identical or similar to the processor 602 and that are communicatively coupled to the interconnection bus.

The processor 602 of FIG. 6 is coupled to a chipset 606, which includes a memory controller 608 and a peripheral input/output (I/O) controller 610. As is well known, a chipset typically provides I/O and memory management functions as well as a plurality of general purpose and/or special purpose registers, timers, etc. that are accessible or used by one or more processors coupled to the chipset 606. The memory controller 608 performs functions that enable the processor 602 (or processors if there are multiple processors) to access a system memory 612 and a mass storage memory 614, that may include either or both of an in-memory cache (e.g., a cache within the memory 612) or an on-disk cache (e.g., a cache within the mass storage memory 614).

The system memory 612 may include any desired type of volatile and/or non-volatile memory such as, for example, static random access memory (SRAM), dynamic random access memory (DRAM), flash memory, read-only memory (ROM), etc. The mass storage memory 614 may include any desired type of mass storage device. For example, if the computing device 601 is used to implement a module 616 (e.g., the various modules to determine and verify eligibility for a prescription drug discount program and other modules as herein described). The mass storage memory 614 may include a hard disk drive, an optical drive, a tape storage device, a solid-state memory (e.g., a flash memory, a RAM memory, etc.), a magnetic memory (e.g., a hard drive), or any other memory suitable for mass storage. As used herein, the terms module, block, function, operation, procedure, routine, step, and method refer to tangible computer program logic or tangible computer executable instructions that provide the specified functionality to the computing device 601, the system 100, and the various servers and other devices described herein. Thus, a module, block, function, operation, procedure, routine, step, and method can be implemented in hardware, firmware, and/or software. In one embodiment, program modules and routines are stored in mass storage memory 614, loaded into system memory 612, and executed by a processor 602 or can be provided from computer program products that are stored in tangible computer-readable storage mediums (e.g. RAM, hard disk, optical/magnetic media, etc.).

The peripheral I/O controller 610 performs functions that enable the processor 602 to communicate with a peripheral input/output (I/O) device 624, a network interface 626, a local network transceiver 628, (via the network interface 626) via a peripheral I/O bus. The I/O device 624 may be any desired type of I/O device such as, for example, a keyboard, a display (e.g., a liquid crystal display (LCD), a cathode ray tube (CRT) display, etc.), a navigation device (e.g., a mouse, a trackball, a capacitive touch pad, a joystick, etc.), etc. The I/O device 624 may be used with the module 616, etc., to receive data from the transceiver 628, send the data to the backend components of the system 100, and perform any operations related to the methods as described herein. The local network transceiver 628 may include support for a Wi-Fi network, Bluetooth, Infrared, or other wireless data transmission protocols. In other embodiments, one element may simultaneously support each of the various wireless protocols employed by the computing device 601. For example, a software-defined radio may be able to support multiple protocols via downloadable instructions. In operation, the computing device 601 may be able to periodically poll for visible wireless network transmitters (both cellular and local network) on a periodic basis. Such polling may be possible even while normal wireless traffic is being supported on the computing device 601. The network interface 626 may be, for example, an Ethernet device, an asynchronous transfer mode (ATM) device, an 802.11 wireless interface device, a DSL modem, a cable modem, a cellular modem, etc., that enables the device 103 and/or system 200 to communicate with another computer system having at least the elements described in relation to the system 100.

While the memory controller 608 and the I/O controller 610 are depicted in FIG. 6 as separate functional blocks within the chipset 606, the functions performed by these blocks may be integrated within a single integrated circuit or may be implemented using two or more separate integrated circuits. The computing environment 600 may also implement the module 616 on a remote computing device 630. The remote computing device 630 may communicate with the computing device 601 over an Ethernet link 632. In some embodiments, the module 616 may be retrieved by the computing device 601 from a cloud computing server 634 via the Internet 636. When using the cloud computing server 634, the retrieved module 616 may be programmatically linked with the computing device 601. The module 616 may be a collection of various software platforms including artificial intelligence software and document creation software or may also be a Java® applet executing within a Java® Virtual Machine (JVM) environment resident in the computing device 601 or the remote computing device 630. The module 616 may also be a “plug-in” adapted to execute in a web-browser located on the computing devices 601 and 630. In some embodiments, the module 616 may communicate with back end components 638 such as the servers 102, 104, 106 of FIG. 1 via the Internet 636.

The system 600 may include but is not limited to any combination of a LAN, a MAN, a WAN, a mobile, a wired or wireless network, a private network, or a virtual private network. Moreover, while only one remote computing device 630 is illustrated in FIG. 6 to simplify and clarify the description, it is understood that any number of client computers are supported and can be in communication within the system 600.

The user devices, computers and servers described herein may be general purpose computers that may have, among other elements, a microprocessor (such as from the Intel Corporation, AMD or Motorola); volatile and non-volatile memory; one or more mass storage devices (i.e., a hard drive); various user input devices, such as a mouse, a keyboard, or a microphone; and a video display system. The user devices, computers and servers described herein may be running on any one of many operating systems including, but not limited to WINDOWS, UNIX, LINUX, MAC OS, or Windows (XP, VISTA, etc.). It is contemplated, however, that any suitable operating system may be used for the present invention. The servers may be a cluster of web servers, which may each be LINUX based and supported by a load balancer that decides which of the cluster of web servers should process a request based upon the current request-load of the available server(s).

The user devices, computers and servers described herein may communicate via networks, including the Internet, WAN, LAN, Wi-Fi, other computer networks (now known or invented in the future), and/or any combination of the foregoing. It should be understood by those of ordinary skill in the art having the present specification, drawings, and claims before them that networks may connect the various components over any combination of wired and wireless conduits, including copper, fiber optic, microwaves, and other forms of radio frequency, electrical and/or optical communication techniques. It should also be understood that any network may be connected to any other network in a different manner. The interconnections between computers and servers in system are examples. Any device described herein may communicate with any other device via one or more networks.

The example embodiments may include additional devices and networks beyond those shown. Further, the functionality described as being performed by one device may be distributed and performed by two or more devices. Multiple devices may also be combined into a single device, which may perform the functionality of the combined devices.

The various participants and elements described herein may operate one or more computer apparatuses to facilitate the functions described herein. Any of the elements in the above-described Figures, including any servers, user devices, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, or Perl using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that the present invention as described above can be implemented in the form of control logic using computer software in a modular or integrated manner. Based on the disclosure and teachings provided herein, a person of ordinary skill in the art may know and appreciate other ways and/or methods to implement the present invention using hardware, software, or a combination of hardware and software.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. A recitation of “a”, “an” or “the” is intended to mean “one or more” unless specifically indicated to the contrary. Recitation of “and/or” is intended to represent the most inclusive sense of the term unless specifically indicated to the contrary.

While the present disclosure may be embodied in many different forms, the drawings and discussion are presented with the understanding that the present disclosure is an exemplification of the principles of one or more inventions and is not intended to limit any one of the inventions to the embodiments illustrated.

The present disclosure provides a solution to the long-felt need described above. In particular, the systems and methods described herein may be configured for improving prescription benefits systems that employ electronic prescription data. Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure covers all such modifications and variations provided they come within the scope of the following claims and their equivalents.

What is claimed:

1. A method for determining the eligibility of a prescription indicated within a set of electronic prescription drug data for a prescription drug discount program, the method comprising:
receiving a first stream of electronic prescription data;
determining if a prescription data set of the received first stream of electronic prescription data is eligible for a prescription drug discount program;
in response to determining that the prescription data set is eligible for the prescription drug discount program, creating an eligibility record;
receiving a second stream of electronic prescription data;
determining if the eligibility record matches the second stream of electronic prescription data;
in response to determining that the eligibility record matches the second stream of electronic prescription data, sending a confirmation message to a pharmacy server.

2. The method of claim 1, wherein at least one of the first stream of electronic prescription data or the second stream of electronic prescription data includes data in NCPDP SCRIPT format.

3. The method of claim 1, further comprising processing at least one of the first stream of electronic prescription data or the second stream of electronic prescription data into a common data specification.

4. The method of claim 3, wherein the common data specification includes one or more of patient information, a date for the prescription data set, a prescriber, a drug, a hospital location, and a provider file.
